(19) United States
(12) Patent Application Publication
(10) Pub. No.: US 2019/0025603 A1
(43) Pub. Date: Jan. 24, 2019

(54) OPTICAL DEVICE FOR CREATING THREE-DIMENSIONAL EFFECT FROM A TWO-DIMENSIONAL DISPLAY SCREEN

(71) Applicant: John Stephen HUDGINS, CHRISTIANSBURG, VA (US)

(72) Inventor: John Stephen HUDGINS, CHRISTIANSBURG, VA (US)

(21) Appl. No.: 16/041,424

(22) Filed: Jul. 20, 2018

Related U.S. Application Data
(60) Provisional application No. 62/604,821, filed on Jul. 21, 2017.

(51) Int. Cl. G02B 27/22; G02B 5/04

(52) U.S. Cl. CPC G02B 27/2242; G02B 27/225; G02B 5/045

(57) ABSTRACT

An optical device for creating a three-dimensional effect from a two-dimensional display screen includes a first prism having a lower surface placed adjacent to the display screen and an upper surface opposite the lower surface and a second prism having a lower surface placed adjacent to the display screen with the second prism positioned next to the first prism. A first image displayed on the display screen follows a first path of light directed into the lower surface of the second prism, out of the second prism, into the first prism, and out of the upper surface of the first prism. A second image displayed on the display screen follows a second path of light directed into the lower surface of the first prism and out of the upper surface of the first prism.

### CROSS-REFERENCE TO RELATED APPLICATIONS

The present application claims priority to U.S. Provisional Patent Application Ser. No. 62/604,821 filed on Jul. 21, 2017, the entire disclosures of which are incorporated herein by reference.

### TECHNICAL FIELD

The present invention relates to an optical device and associated system that allows for the viewing of 3D images on a smartphone or other small digital devices with a display screen.

### BACKGROUND OF THE INVENTION

Many virtual reality (VR) viewers are smartphone based and allow the phone to be inserted into the viewer to provide the display for the 3D illusion. Typically, two separate images are displayed side by side in the smartphone display. One of the images shows what the user's right eye would see if he or she was seeing the actual object or scene while the other image shows what the left eye would see. The device is constructed so that the user's right eye sees only the right image and the left eye sees only the left image. Optical elements between the user and smartphone images compensate for the very short focal lengths. Typically, the smartphone images are altered prior to display to counteract the pincushion and other aberrations inherent in the short focal length convex lenses. The user's brain combines the two disparate images and creates the 3D viewing illusion.

While these 3D VR images can be quite convincing, there are tradeoffs and limitations with these viewers. Although some of the existing VR viewers allow for some adjustments in focus, these adjustments are typically limited, and so users who wear glasses which correct for abnormalities such as an astigmatism or which have too high a prescription cannot use the VR viewers without also wearing their glasses. However, glasses may not fit well in the VR viewers, may invite scratches, or may fog up. These problems can be exacerbated by glasses which include bifocal lenses.

Many of the VR viewers include straps that go over the head of a uses to carry the weight of the VR system and these can interact with the wearer's hairdo. They also have to be adjusted for fit and as such are less user friendly for a quick 3D viewing of an object or a short video. Likewise, as the VR viewers are placed directly on a user, there are hygiene issues associated with skin and hair. These can be addressed but do elevate the hassle factor. VR viewers are typically too large to fit in a handbag or coat pocket. Those VR viewers designed for use with a smartphone are often restricted to one smartphone brand or model, and, when they can be used with other brands and models, typically require an adapter. Most VR viewers prevent the user from seeing his or her environment and therefore represent a safety hazard.

Other systems that allow 3D illusion with smartphones or other digital display devices require the application/installation of a lenticular device which looks much like transparent corduroy and allows alternate right and left images from the display screen to be seen by the user at a particular location in space. Likewise, parallax barrier displays can be incorporated in digital displays or attached to an existing display to allow the creation of a 3D illusion. Both of these types of systems have downsides, but the most obvious is that either the smartphone or other display device screen must be altered or another piece of equipment attached to the screen and aligned with the screen. These technologies are best selected when the device is going to be made a permanent or semipermanent 3D display device and not something that could be easily used in a few seconds for 3D viewing of an image or a short video with the user's smartphone. Other systems which have been used with 3D TV could theoretically be used with smartphones or other digital displays. These systems typically use shutter glasses which rapidly occlude first the right eye leaving the left eye open and then rapidly switching to the left eye and leaving the right eye open; each time being in sync with an alternating image on the display screen with alternating right and left eye images. This type of system has the problem of the user having to wear special glasses and the fact that half or more of the light is blocked from the screen significantly dimming the image. These shutter glasses are active devices and require batteries to be changed or recharged. They are also fairly fragile and would need to be protected in a case when not being used.

The use of anaglyph glasses and an altered display on the smartphone is another possible option. These systems use the familiar red and green glasses to select which part of an altered image is seen by each eye. These also block a significant fraction of the light from the device to the user and in addition alter color perception. Furthermore, it requires wearing red and green glasses.

Other methods of stereo viewing from the first Wheatstone viewers and many forms of stereo viewers that have followed could be used with images on a smartphone but would typically require glasses of some type or a viewer like a Viewmaster or other similar device.

Thus, there remains a need for an improved system that allows for the viewing of 3D images on a smartphone or other small digital devices with a display screen.

### SUMMARY OF THE INVENTION

The present invention relates to an optical device and associated system that allows for the viewing of 3D images on a smartphone or other small digital devices with a display screen. In particular, the optical device of the present invention represents a new and unique way of generating a 3D viewing illusion simply by placing the optical device on the display screen of a digital device, such as a smartphone, as described in detail below.

In one exemplary optical device of the present invention, a parallelogram prism is formed of a first material and includes a lower surface, an upper surface opposite the lower surface, a first side surface extending between the lower surface and the upper surface at an angle, and a second side surfaces extending between the lower surface and the upper surface at an angle and opposite the first side surface. Similarly, a triangular prism is formed of a second material and includes a lower surface, a first side surface extending from the lower surface at an angle, and a second side surface. In the exemplary optical device, a thin air gap is defined between the second side surface of the parallelogram prism and the first side surface of the triangular prism.

According to the present invention, light along a first light path passes through the triangular prism from a point at the lower surface to a point at the first side surface. The light along the first light path is refracted when passing into the air gap and is refracted once again when passing into the parallelogram prism at point on the second side surface. Light along the first light path then passes through the parallelogram prism before exiting the upper surface of the parallelogram prism where it is refracted toward a user's right eye.

Light along a second light path passes through the parallelogram prism where it is reflected within the parallelogram prism at the first side surface towards the second side surface of the parallelogram prism and then reflected within the parallelogram prism at the second side surface towards the upper surface of the parallelogram prism. The light along the second light path then exits the upper surface of the parallelogram prism where it is refracted toward a user's left eye.

A digital device, such as a smartphone, includes a display screen with a first image and a second image displayed on the screen. The optical device is placed on the screen of the smartphone such that the first image is projected through the triangular prism, air gap, and parallelogram prism to the user's right eye, as described above. Likewise, the second image is projected through the parallelogram prism to the user's left eye, as described above. Due to the divergence of the two light paths exiting the parallelogram prism, the first image carried to the user's right eye is not visible to the user's left eye and the second image carried to the user's left eye is not visible to the user's right eye. The two images represent an optical pair such that the user perceives a 3D illusion roughly in the plane of the smartphone.

### DESCRIPTION OF THE DRAWINGS

FIG. 1 illustrates two paths of light traveling through materials having different refractive indices;

FIG. 2 illustrates two paths of light traveling through materials having different refractive indices;

FIG. 3 illustrates two paths of light traveling through materials having different refractive indices;

FIG. 4 is a side view of an exemplary optical device of the present invention showing two paths of light traveling through the device;

FIG. 5 is a perspective view of a digital device having a display screen displaying two images;

FIG. 6 is a side view of the optical device of FIG. 4 positioned on the digital device of FIG. 5 showing the paths of light for each of the two images reaching the eyes of a user;

FIG. 7 is a perspective view of the arrangement of FIG. 6;

FIG. 8 is a side view of a second exemplary optical device of the present invention positioned on the digital device of FIG. 5 showing the paths of light for each of the two images;

FIG. 9 is a side view of a third exemplary optical device of the present invention positioned on the digital device of FIG. 5 showing the paths of light for each of the two images;

FIG. 10 is a side view of a fourth exemplary optical device of the present invention positioned on the digital device of FIG. 5 showing the paths of light for each of the two images; and

FIG. 11 is a side view of a fifth exemplary optical device of the present invention positioned on the digital device of FIG. 5 showing the paths of light for each of the two images.

### DESCRIPTION OF THE INVENTION

The present invention relates to an optical device and associated system that allows for the viewing of 3D images on a smartphone or other small digital devices with a display screen. In particular, the optical device of the present invention represents a new and unique way of generating a 3D viewing illusion simply by placing the optical device on the display screen of a digital device, such as a smartphone, as described in detail below.

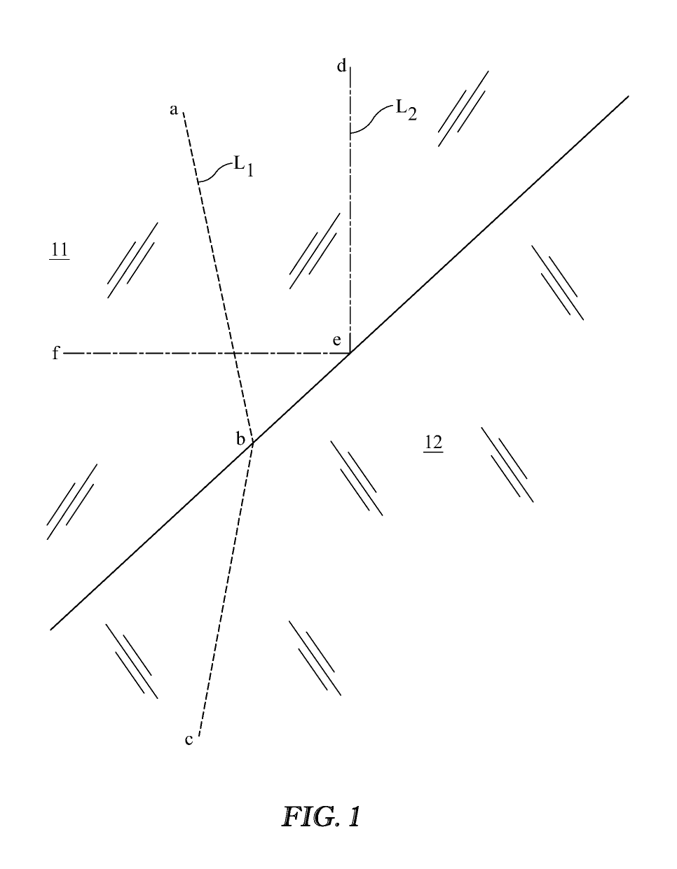

Referring first to FIG. 1, when light passes at a relatively shallow angle from a first material 11 with a first refractive index (n₁) into a second material 12 with a second refractive index (n₂) lower than the first refractive index (n₁), light along a light path L₁ is bent or refracted as it passes through the interface from the first material 11 into the second material 12. One such refracted path is illustrated as path a-b-c shown in FIG. 1. However, if light along a light path L₂ strikes the interface at an angle that is greater than a certain critical angle (e.g., 42° for glass with a refractive index of 1.5) and the interface is smooth, the light along the light path L₂ will not pass through the interface but will instead be reflected as if it had struck a mirror. One such reflected path is illustrated as path d-e-f in FIG. 1. For such a reflection to occur, the interface does not need to be silvered.

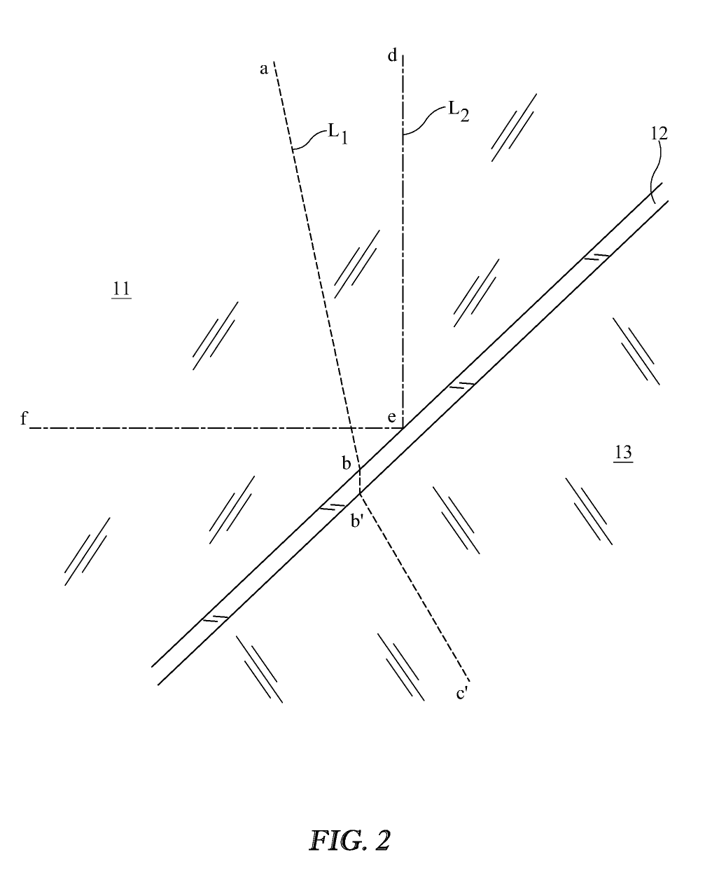

Referring now to FIG. 2, if the region of the second material 12 with the lower refractive index (n₂) is very thin and separates the first material 11 from a third material 13 which has a third refractive index (n₃) higher than the refractive index (n₂) of the second material 12, light along the light path L₂ striking the interface between the first materials 11 and the second material 12 at an angle greater than the critical angle will continue unaffected along the path d-e-f. However, light along the light path L₁ passing through the first material 11 along line a-b will refract when passing into the second material 12 and pass through the second material 12 along line b-b′. The light along the light path L₁ will then refract once again when passing into the third material 13 and pass through the third material 13 along line b′-c′.

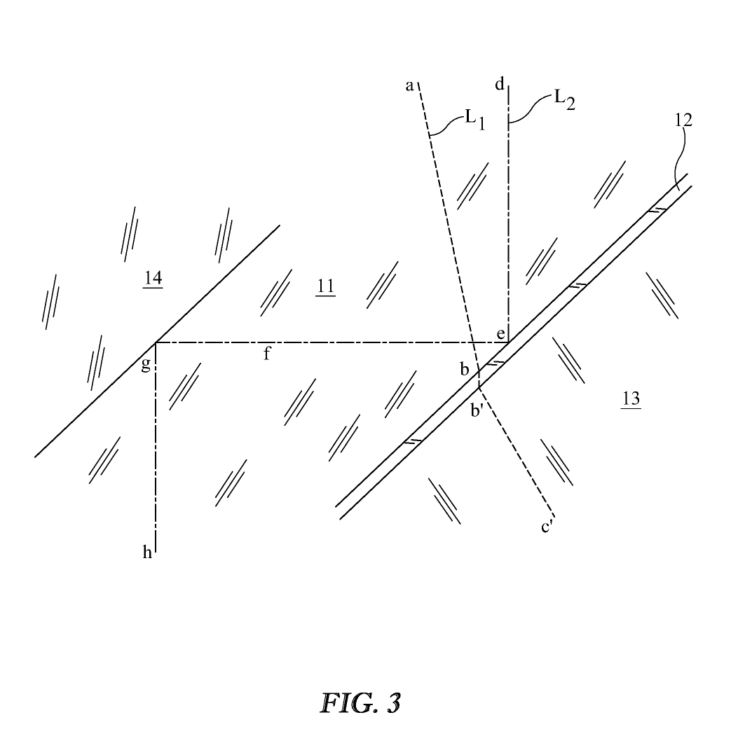

Referring now to FIG. 3, where an additional interface exists between the first material 11 and a fourth material 14, which has a fourth refractive index (n₄) lower than the refractive index (n₁) of the first material 11. As the light along the light path L₂ continues through the first material 11 along path d-e-f and strikes the interface between the first material 11 and the fourth material 14 at point g, if the angle of incidence is greater than the critical angle between the first material 11 and the fourth material 14 and this interface is smooth, the light along the light path L₂ will reflect and proceed along line g-h. Of course, the inclusion of the fourth material 14 has no effect on the light path L₁ passing through the first material 11, second material 12, and third material 13 along path a-b-b′-c′.

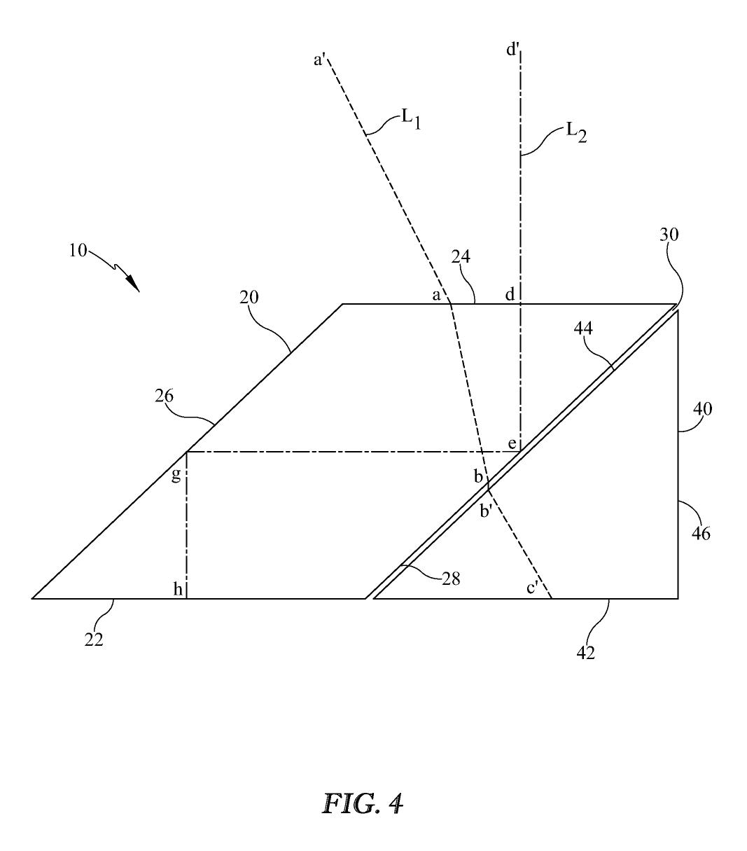

Referring now to FIG. 4, in one exemplary optical device 10 of the present invention, a parallelogram prism 20 is formed of the first material 11 which includes upper and lower boundaries. In particular, the parallelogram prism 20 includes a lower surface 22, an upper surface 24 opposite the lower surface 22, a first side surface 26 extending between the lower surface 22 and the upper surface 24 at an angle, and a second side surfaces 28 extending between the lower surface 22 and the upper surface 24 at an angle and opposite the first side surface 26.

Similarly, a triangular prism 40 is formed of the third material 13 with the triangular prism 40 including a lower surface 42, a first side surface 44 extending from the lower surface 42 at an angle, and a second side surface 46. In the exemplary optical device 10, a thin air gap 30 is defined between the second side surface 28 of the parallelogram prism 20 and the first side surface 44 of the triangular prism 40 such that the air within the gap 30 is the second material 12 described above with respect to FIGS. 1-3.

In some embodiments, a small spacer (not shown) is positioned between the second side surface 28 of the parallelogram prism 20 and the first side surface 44 of the triangular prism 40 to maintain the air gap 30. In some other embodiments, it is contemplated that merely positioning the parallelogram prism 20 and the triangular prism 40 next to one another without forceably pressing them together will naturally leave a sufficient air gap 30 between the second side surface 28 of the parallelogram prism 20 and the first side surface 44 of the triangular prism 40. To this end, it is noted that the elements of the optical device shown in the Figures are exaggerated for clarity and do not necessarily reflect the relative dimensions of the optical device of the present invention. In still other embodiments, rather than including an air gap 30, it is contemplated that a thin intermediate member can be included between the second side surface 28 of the parallelogram prism 20 and the first side surface 44 of the triangular prism 40 without departing from the spirit and scope of the present invention. In particular, such an intermediate member would have a refractive index lower than the first material 11 of the parallelogram prism 20 and lower than the third material 13 of the triangular prism 13 so as to operate in substantially the same manner as the air gap 30 shown in FIG. 4.

As shown in FIG. 4, light along the light path L₁ passes through the triangular prism 40 from a point c′ at the lower surface 42 to a point b′ at the first side surface 44. The light along the light path L₁ is refracted when passing into the air gap 30 to extend along line b′-b through the air gap 30. The light along the light path L₁ is refracted once again when passing into the parallelogram prism 20 at point b on the second side surface 28 and passes through the parallelogram prism 20 along line b-a before exiting the upper surface 24 of the parallelogram prism 20 where the light along the light path L₁ is refracted to progress along line a-a′.

Referring still to FIG. 4, the light along the light path L₂ passes through the parallelogram prism 20 along path h-g-e-d and exits the upper surface 24 of the parallelogram prism 20 at point d where it is refracted to progress along line d-d′. With respect to the reflection of the light along the light path L₂ at point g, and with reference to FIGS. 3-4, air adjacent to the first side surface 26 of the parallelogram prism 20 is the fourth material 14 described above with respect to FIG. 3. As discussed further below, in other embodiments, an additional member is included adjacent to the first side surface 26 of the parallelogram prism 20 without departing from the spirit and scope of the present invention.

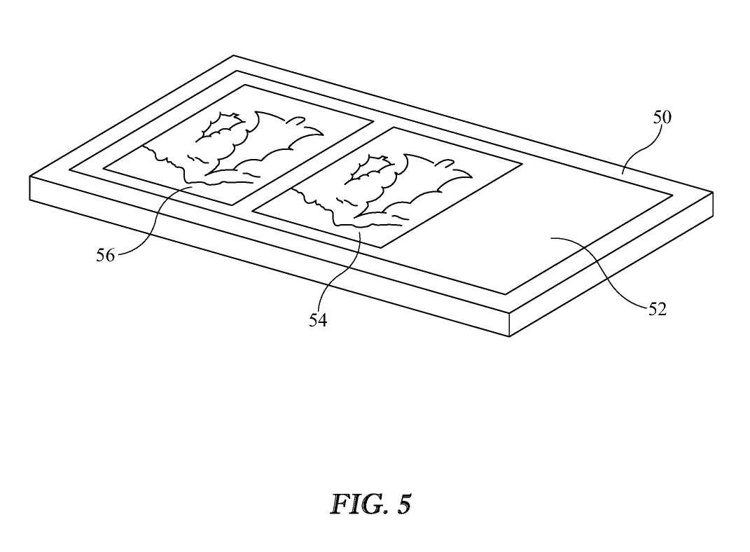

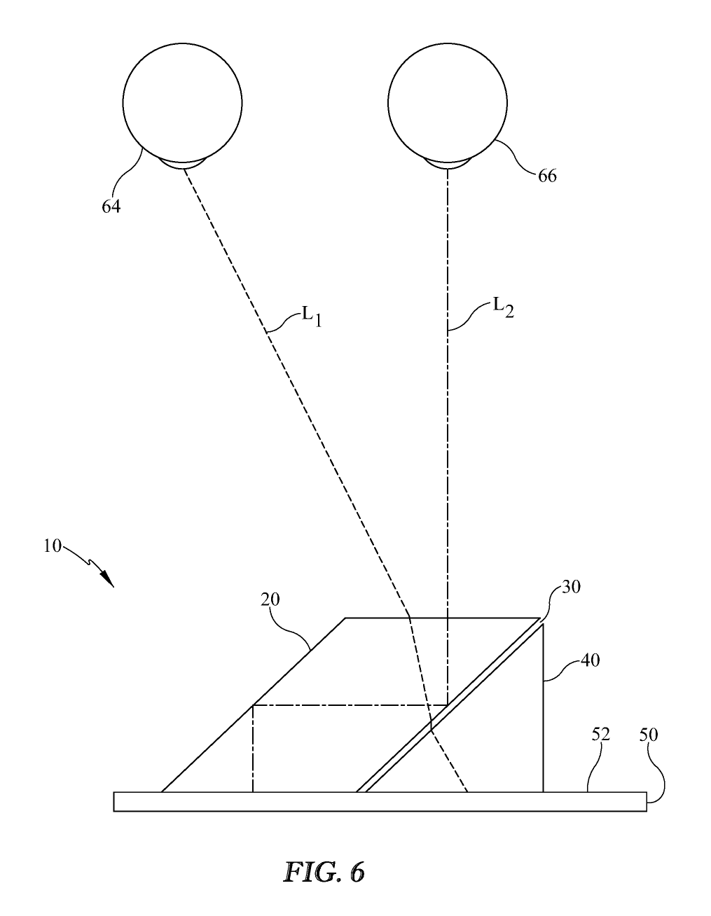

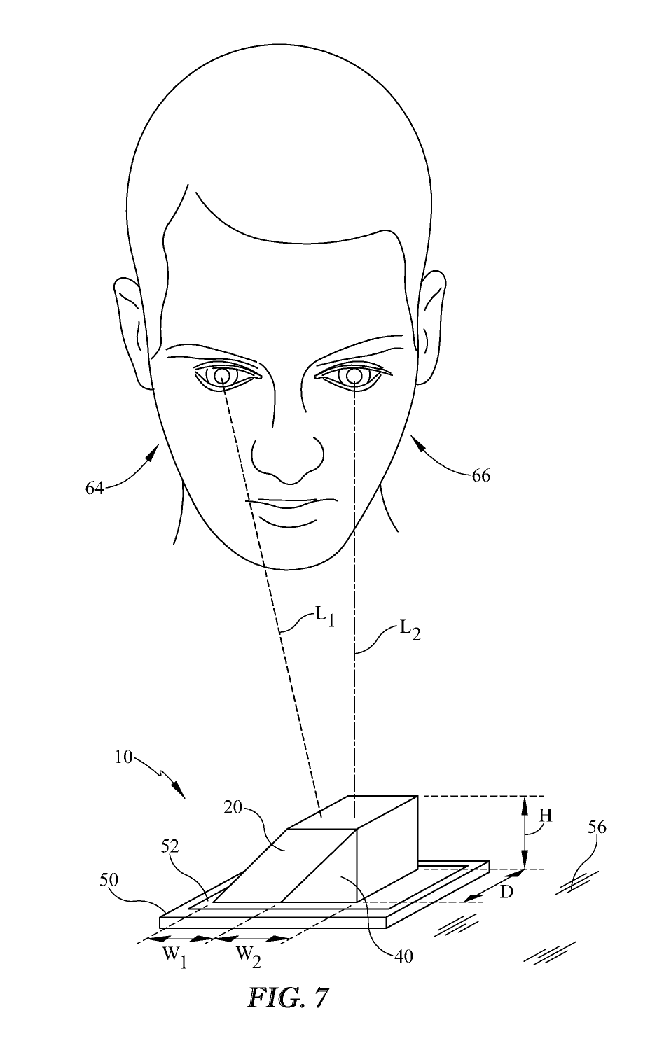

Referring now to FIGS. 5-7, a digital device 50, such as a smartphone 50, includes a display screen 52 with a first image 54 and a second image 56 displayed on the screen 52. As shown in FIGS. 6-7, the optical device 10 is placed on the screen 52 of the smartphone 50 such that the first image 54 follows the light path L₁ and the second image 56 follows the light path L₂. In particular, the first image 54 is projected through the triangular prism 40, air gap 30 (not shown in FIG. 7), and parallelogram prism 20 along the light path L₁ following the path c′-b′-b-a-a′ shown in FIG. 4 to the user's right eye 64, and the second image 56 is projected through parallelogram prism 20 along the light path L₂ following the path h-g-e-d-d′ shown in FIG. 4 to the user's left eye 66. Due to the divergence of the two light paths L₁, L₂ exiting the parallelogram prism 20, the first image 54 carried to the user's right eye 64 is not visible to the user's left eye 66 and the second image 56 carried to the user's left eye 66 is not visible to the user's right eye 64. As discussed in detail below, the two images 54, 56 represent an optical pair such that the user perceives a 3D illusion roughly in the plane of the smartphone 50.

As shown in FIG. 7, a typical but not exclusive configuration for the use of the present invention is to place the smartphone 50 on a table 56 with the screen 52 facing upward and the display device 10 resting on the screen 52 of the smartphone 50 aligned with the first image 54 and the second image 56. The user's head is positioned above the smartphone 50 and display device 10 such that the images 54, 56 are directed into the user's eyes 64, 66 along the light paths L₁, L₂, as discussed above. The user will see a 3D illusion consisting either of a static 3D image, if the images 54, 56 are fixed, or a 3D movie if the images 54, 56 represent a stereo pair of movie images that are synched together. However, this is not the only way the display device 10 can be used. In particular, the smartphone 50 can be held in one hand at any number of angles with the display device 10 held on the screen 52 of the smartphone 50 by any number of means known in the art.

To this end, while the optical device 10 of the present invention can, in some embodiments be permanently or semipermanently affixed to the smartphone, it is contemplated that the optical device 10 can also simply be held adjacent to the smartphone 50 so that it can be readily positioned and removed. As such, a user could simply taking the optical device 10 from a pocket, purse, or the like and hold it adjacent to the smartphone 50 to allow a quick viewing of an image or short video. When done, the optical device 10 is then placed back in the pocket, purse, or the like.

In some exemplary embodiments of the present invention, the parallelogram prism 20 and triangular prism 40 are attached to one another in order to maintain proper alignment of the air gap 30 defined between the parallelogram prism 20 and triangular prism 40. In other embodiments, however, it is contemplated that the parallelogram prism 20 and triangular prism 40 are separable from each other. In these embodiments, a user must first properly align the parallelogram prism 20 and the triangular prism 40 to properly see the 3D effect of the present invention. Although not show, various means are available to ensure proper alignment of the parallelogram prism 20 and the triangular prism 40 without requiring permanent attachment. For example, the optical device of the present invention can further include one or more plates, or a frame, connecting the vertical edges on or both sides of the parallelogram prism 20 and triangular prism 30 while leaving the top (viewing side) and bottom (smartphone side) uncovered. Not only would such a frame ensure proper alignment of the parallelogram prism 20 and the triangular prism 40, but it would also provide a natural place to hold, handle, and position the optical device with a thumb on one side and index and middle fingers on the other side. The parallelogram prism 20 and the triangular prism 40 can be connected to the plates, or frame, through gluing, crimping, fusing, taping, or the like. The material for the plates, or frame, is not limited and can comprise metal, plastic, or any other material suitable for rigidly supporting the parallelogram prism 20 and the triangular prism 40.

While not nearly as immersive an experience as a VR viewer, the optical device of the present invention has several advantages with respect to ease of use and applicability to any smartphone without use of an adapter or without removal of the smartphone case. Because a user's eyes are not placed up to the optical device, the optical device of the present invention provides substantial advantages for hygiene and for use by those wearing glasses or bifocals.

Furthermore, the optical device of the present invention would not require modification of the smartphone screen or require a precisely aligned device to be attached to the screen. Further still, no special glasses would be required and the invention does not require any battery power.

Referring now to FIGS. 4 and 7 in particular, as previously discussed, the parallelogram prism 20 is made of a first material 11 having a refractive index (n₁) greater than the refractive index (n₂) of the second material 12 (i.e., the air gap 30). Likewise, the triangular prism 40 is made of a third material 13 having a refractive index (n₃) greater than the refractive index (n₂) of the second material (i.e., the air gap 30).

With respect to the second material 12, in embodiments where an air gap 30 is defined between the parallelogram prism 20 and the triangular prism 40, the refractive index (n₂) of the air gap is about 1.0. In other embodiments where a thin intermediate member is included between the second side surface 28 of the parallelogram prism 20 and the first side surface 44 of the triangular prism 40, the second material 12 of the thin intermediate member still has a relative low refractive index (n₂) as compared to the refractive index (n₁) of the first material 11 and the refractive index (n₃) of the third material 13.

With respect to the first material 11 of the parallelogram prism 20, in some particular embodiment of the present invention, the first material 11 of the parallelogram prism 20 is made of a plastic or glass. The refractive index (n₁) of the first material 11 is typically between about 1.4 and about 2.0. In particular, in some embodiments, the first material 11 of the parallelogram prism 20 is a plastic having a refractive index (n₁) of about 1.49. In other embodiments, the first material 11 of the parallelogram prism 20 is a glass or high index plastic having a refractive index (n₁) of about 1.7.

With respect to the third material 13 of the triangular prism 40, in some particular embodiment of the present invention, the third material 13 of the triangular prism 40 is made of a plastic or glass. The refractive index (n₃) of the third material 13 is typically between about 1.4 and about 2.0. In particular, in some embodiment, the third material 13 of the triangular prism 40 is a plastic having a refractive index (n₃) of about 1.49. In other embodiments, the third material 13 of the triangular prism 40 is a glass or high index plastic having a refractive index (n₃) of about 1.7.

In some particular embodiments, the parallelogram prism 20 and the triangular prism 40 are each made of the same material.

Referring still to FIGS. 4 and 7, with respect to the triangular prism 40, in one particular embodiment, the triangular prism 40 is a right angle prism. That is to say the first side surface 44 of the triangular prism 40 forms a 45° angle relative to both the lower surface 42 and the second side surface 46. The height (H) of the triangular prism 40 is about 34 mm and the width (W2) of the triangular prism 40 is about 34 mm. The depth (D) of the triangular prism 40 is 52 mm.

Referring still to FIGS. 4 and 7, with respect to the parallelogram prism 20, in one particular embodiment, the first side surface 26 of the parallelogram prism 20 forms a 45° angle relative to both the lower surface 22 and the upper surface 24. Likewise, the second side surface 28 of the parallelogram prism 20 forms a 45° angle relative to both the lower surface 22 and the upper surface 24. The height (H) of the parallelogram prism 20 is about 34 mm and the width (W1) of the lower surface 22 of the parallelogram prism 20 is about 34 mm. The depth (D) of the parallelogram prism 20 is 52 mm.

The above dimensions of the one particular embodiment of the present invention are specifically chosen for use with an iPhone®, and results in 3D image size visible to the user with a nominal height of 52 mm and a nominal width of 34 mm (which came from combining two images 54, 56 each having a height of 52 mm and a width of 34 mm). This sizing provides a vertical to horizontal image aspect ratio of 1:53 which falls between the 16:9 and 4:3 ratios typically used for smartphones screens. It is believed that substantially similar dimensions are applicable for use with any number of other smartphones or electronic display devices. Furthermore, a person of ordinary skill would readily be able to choose appropriate dimensions and/or materials depending on the particular application desired for the display device of the present invention.

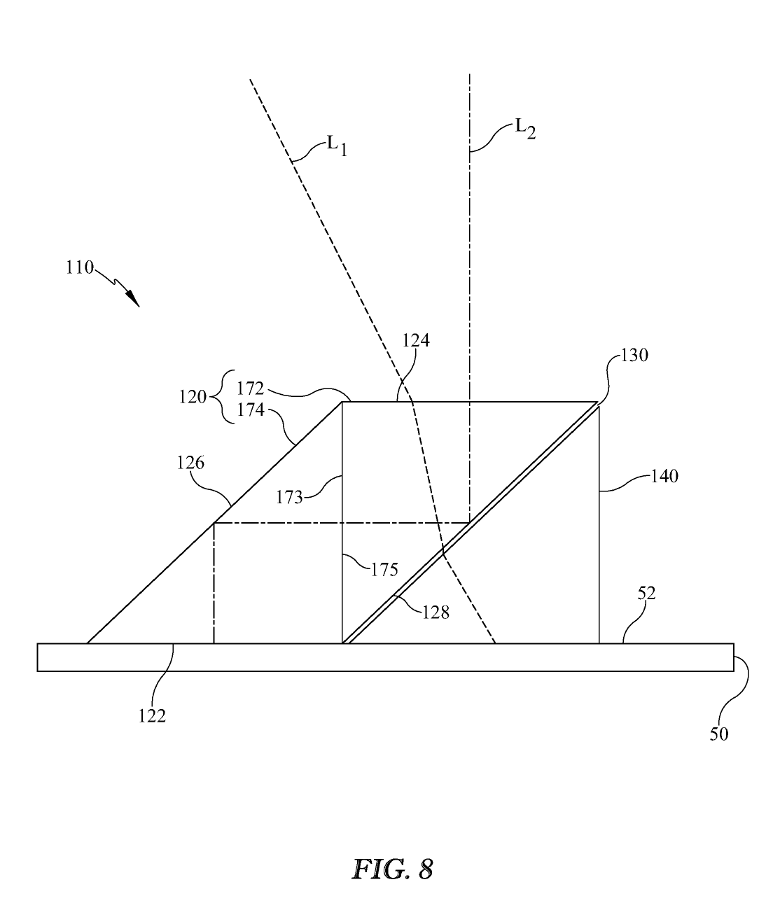

Referring now to FIG. 8, in a second exemplary optical device 110 of the present invention, the parallelogram prism 120 is comprised of two prisms 172, 174 which are connected. In particular, each of the prisms 172, 174 is a triangular prism. The first triangular prism 172 has as its sides the upper surface 124 of the parallelogram prism 120, the second side surface 128 of the parallelogram prism 128, and a mating side surface 173. Likewise, the second triangular prism 174 has as its sides the lower surface 122 of the parallelogram prism 120, the first side surface 126 of the parallelogram prism 120, and a mating side surface 175 which is connected to the mating side surface 173 of the first triangular prism 172. Each of the two triangular prisms 172, 174 which form the parallelogram prism 120 are made of the first material 11. As such, light passing through the interface of the mating side surfaces 173, 175 of the two triangular prism 172, 174 will not experience any reflection or refraction. Accordingly, the resulting parallelogram prism 120 functions in combination with the triangular prism 140 and air gap 130 in substantially the same manner as the parallelogram prism 20, triangular prism 40 and air gap 30 described above with respect to FIGS. 4-7 in directing images from the screen 52 of the smartphone 50 along the first light path L₁ and the second light path L₂ to the user's eyes. In some particular embodiments, the two triangular prism 172, 173 forming the parallelogram prism 120 and the triangular prism 140 are all substantially identical members. That is to say, each of the triangular prism 140, 172, 173 have the same dimensions and are made of a material having the same refractive index.

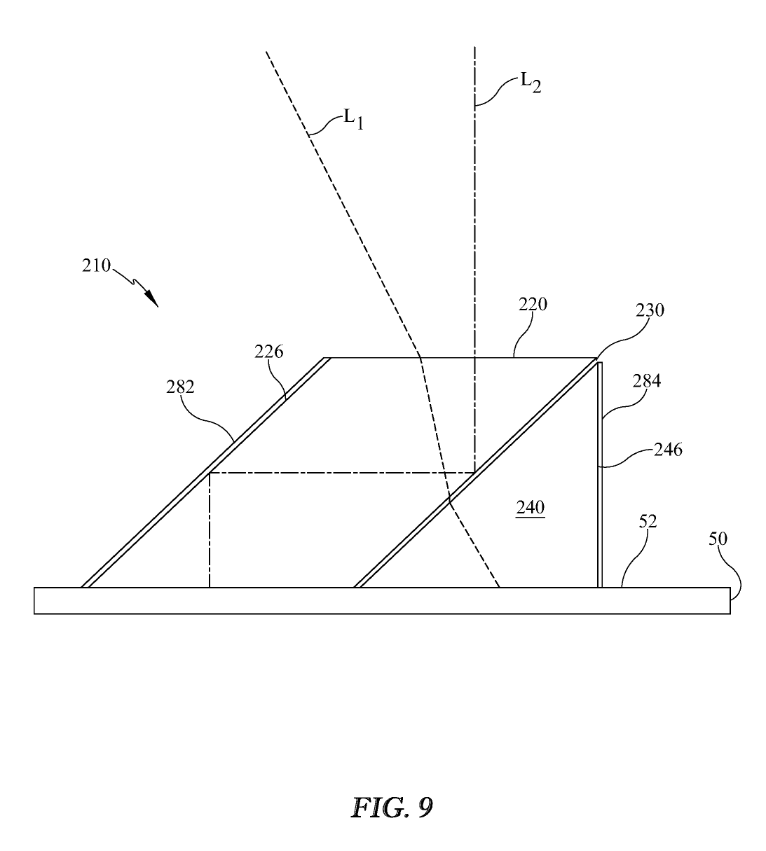

Referring now to FIG. 9, in a third exemplary optical device 210 of the present invention, in addition to the parallelogram prism 220 and triangular prism 240 defining an air gap 230 substantially identical to the parallelogram prism 20, triangular prism 40, and air gap 30 of the optical device 10 of FIGS. 4-7, a first light shield 282 is positioned adjacent to the first side surface 226 of the parallelogram prism 220 and a second light shield 284 is positioned adjacent to the second side surface 246 of the triangular prism 240. These light shields 282, 284 prevent alternate paths for the light from the screen 52 of the smartphone 50 aside from the light paths L₁, L₂ directed to the user's eyes. Furthermore, the contrast is increased by reducing external light illuminating the images.

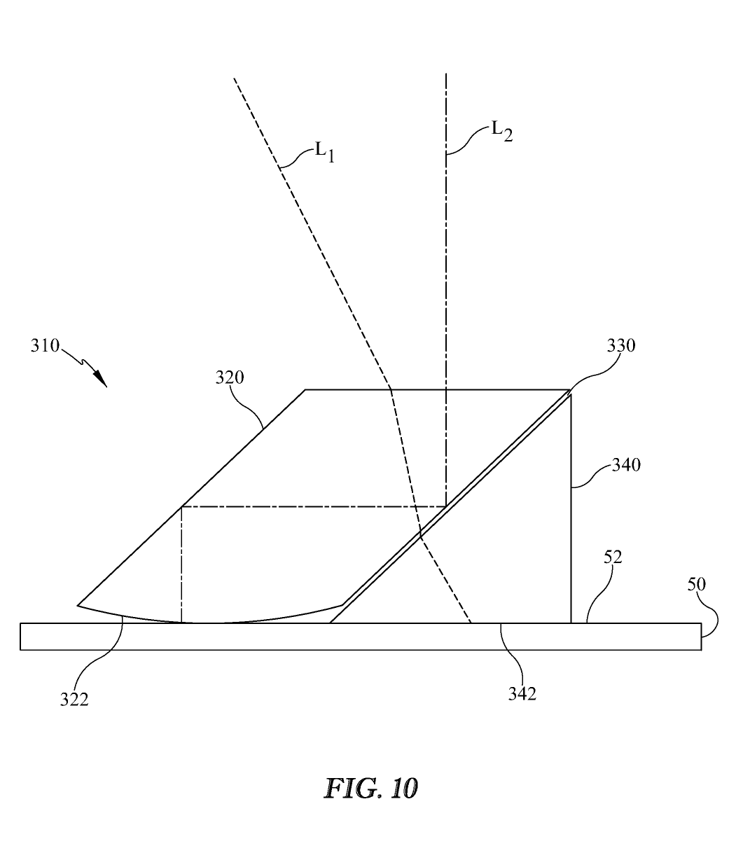

Referring now to FIG. 10, in a fourth exemplary optical device 310 of the present invention, a parallelogram prism 320 and a triangular prism 340 defining an air gap 330 are provided which are substantially identical to the parallelogram prism 20, triangular prism 40, and air gap 30 of the optical device 10 of FIGS. 4-7 except the lower surface 322 of the parallelogram prism 320 has a convex curvature which would magnify the image on the screen 52 of the smartphone 50 aligned with the lower surface 322 (i.e., the second image 56 shown in FIG. 5). Although not shown, it is contemplated that in some embodiments the lower surface 342 of the triangular prism 340 can also be curved in addition to, or in place of the curved lower surface 322 of the parallelogram prism 320. Accordingly, the size and position of the images 54, 56 displayed on the screen 52 of the smartphone 50 can be fine-tuned. For example, in the embodiment shown in FIG. 10, the curved lower surface 322 of the parallelogram prism 320 corrects for the slight difference in lengths of the two light paths L₁, L₂ between the two images on the screen 52 of the smartphone 50 up to the user's eyes. While most people can fuse images of slightly different sizes, fusion is easier if the images are the same size. As discussed below, the correction can also be handled by modifying the size of the display images through software.

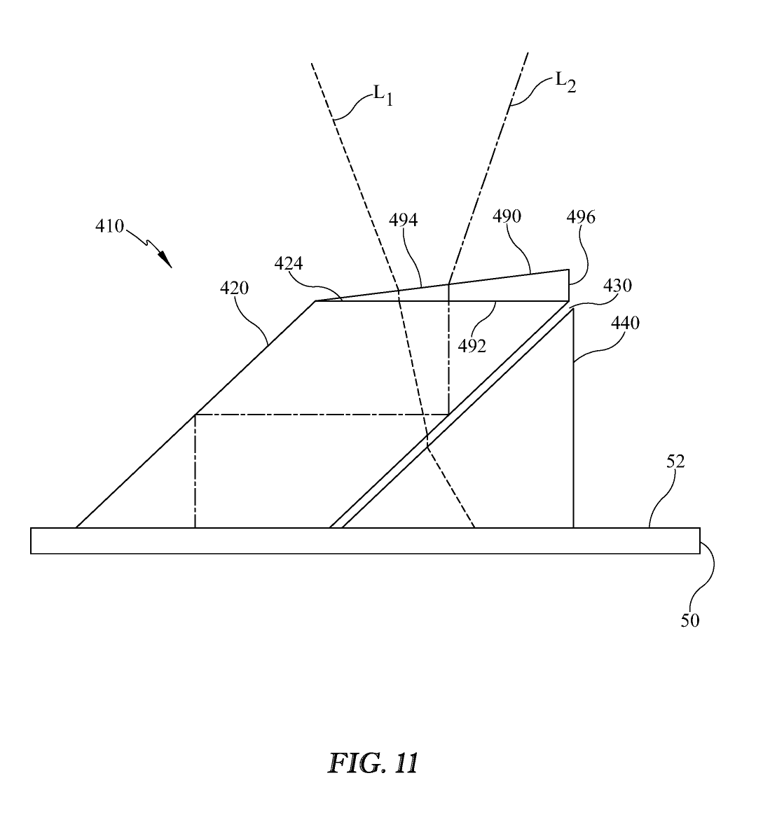

Referring now to FIG. 11, in a fifth exemplary optical device 410, in addition to the parallelogram prism 420 and triangular prism 440 defining an air gap 430 substantially identical to the parallelogram prism 20, triangular prism 40, and air gap 30 of the optical device 10 of FIGS. 4-7, an additional triangular prism 490 is included which is positioned adjacent to the upper surface 424 of the parallelogram prism 420. The additional triangular prism 490 has a lower surface 492, a first side surface 494, and a second side surface 496, but is substantially more shallow than the main triangular prism 440. In other words, the second side surface 496 is relatively short as compared to the lower surface 492 and the first side surface 494. Because of the inclusion of the additional triangular prism 490, after exiting the upper surface 424 of the parallelogram prism 420, the light paths L₁, L₂ are refracted through the additional triangular prism 490 such that the paths of the light paths L₁, L₂ are more normal to the plane of the smartphone screen 26. This corrects for the slightly off vertical viewing angle provided by other embodiments of the present invention.

In addition to the optical device described above, in some embodiments of the present invention, software is provided to run on the digital device, or smartphone. In one exemplary implementation, the software is in the form of an app that is downloaded to the smartphone. In some implementations, the app is opened specifically when a user wants to use the optical device of the present invention. Because different smartphones (and different digital devices) have different screen sizes, the software of the invention allows for manipulation of the display image size on the screen (either larger or smaller) to match the size of the 3D viewer. In this way, the same optical device can be used for different or new phones (or other smaller digital device).

Additionally, the app allows the size of either of the two display images making up the stereo pair to be slightly enlarged versus the other image so as to enhance the stereo effect. Most typically the size of the left most image (i.e., the second image 56 shown in FIG. 5) would be enlarged a few percent to correct for the slightly longer optical path length through the optical device.

Furthermore, since the optical device rests on the screen of the smartphone, in some implementations, the software limits touch inputs to the smartphone to the portions of the screen not covered by the optical device. Control features, such as starting or stopping stereo videos or swiping to the next stereo image can still be input via the uncovered portion of the screen. One of ordinary skill in the art will recognize that additional embodiments are possible without departing from the teachings of the present invention. This detailed description, and particularly the specific details of the exemplary embodiments disclosed therein, is given primarily for clarity of understanding, and no unnecessary limitations are to be understood therefrom, for modifications will become obvious to those skilled in the art upon reading this disclosure and may be made without departing from the spirit or scope of the present invention.

What is claimed is:

1. An optical device for creating a three-dimensional effect from a two-dimensional display screen, comprising:
a first prism including a lower surface for placement adjacent to the display screen and an upper surface opposite the lower surface; and
a second prism including a lower surface for placement adjacent to the display screen with the second prism positioned next to the first prism;
wherein a first path of light projected from the display screen is directed into the lower surface of the second prism, out of the second prism, into the first prism, and out of the upper surface of the first prism; and
wherein a second path of light projected from the display screen is directed into the lower surface of the first prism and out of the upper surface of the first prism.

2. The optical device of claim 1, wherein the first prism is spaced apart from the second prism such that an air gap is defined between the first prism and the second prism.

3. The optical device of claim 1, wherein
the first prism is a parallelogram prism including a first side surface extending between the lower surface and the upper surface and a second side surface extending between the lower surface and the upper surface opposite the first side surface;
the second prism is a triangular prism including a first side surface extending away from the lower surface of the second prism with the first side surface of the triangular prism positioned adjacent to the second side surface of the parallelogram prism.

4. The optical device of claim 3, wherein the first side surface of the triangular prism is spaced apart from the second side surface of the parallelogram prism such that an air gap is defined between the parallelogram prism and the triangular prism.

5. The optical device of claim 1, wherein the first prism has a first refractive index and the second prism has a second refractive index the same as the first refractive index.

6. The optical device of claim 1, wherein
the first prism is comprised of two triangular prisms connected to form a parallelogram prism including a first side surface extending between the lower surface and the upper surface and a second side surface extending between the lower surface and the upper surface opposite the first side surface; and
the second prism is a triangular prism including a first side surface extending away from the lower surface of the second prism with the first side surface of the triangular prism positioned adjacent to the second side surface of the parallelogram prism.

7. The optical device of claim 6, wherein the two triangular prisms of the first prism and the triangular prism of the second prism are each right angle prisms.

8. The optical device of claim 3, further comprising a first light shield is positioned adjacent to the first side surface of the parallelogram prism and a second light shield is positioned adjacent to the second side surface of the triangular prism

9. The optical device of claim 3, wherein the lower surface of the parallelogram prism has a convex curvature.

10. An optical device for creating a three-dimensional effect from a two-dimensional display screen, comprising:
a parallelogram prism including a lower surface positioned adjacent to the display screen, an upper surface opposite and substantially parallel to the lower surface, a first side surface extending at a 45° angle between the lower surface and the upper surface, and a second side surface extending at a 45° angle between the lower surface and the upper surface opposite the first side surface; and
a right angle prism positioned next to the parallelogram prism, the right angle prism including a lower surface positioned adjacent to the display screen, a first side surface extending at a 45° angle away from the lower surface and positioned adjacent to the second side surface of the parallelogram prism, and a second side surface extending away from the lower surface;
wherein a first path of light projected from the display screen is directed into the lower surface of the right angle prism, out of the first side surface of the right angle prism, into the second side surface of the parallelogram prism, and out of the upper surface of the parallelogram prism; and
wherein a second path of light projected from the display screen is directed into the lower surface of the parallelogram prism and out of the upper surface of the parallelogram prism.

11. An optical device for creating a three-dimensional effect from a two-dimensional display screen, comprising:
a parallelogram prism including a lower surface positioned adjacent to the display screen, an upper surface opposite and substantially parallel to the lower surface, a first side surface extending between the lower surface and the upper surface, and a second side surface extending between the lower surface and the upper surface opposite the first side surface; and
a triangular prism positioned next to the parallelogram prism, the triangular prism including an lower surface positioned adjacent to the display screen, a first side surface extending at a 45° angle away from the lower surface and positioned adjacent to the second side surface of the parallelogram prism, and a second side surface extending away from the lower surface;
wherein a first image displayed on the display screen follows a first light path which:
(1) refracts as it passes through the lower surface of the triangular prism towards the first side surface of the triangular prism,
(2) refracts as it passes through the first side surface of the triangular prism towards the second side surface of the parallelogram prism,
(3) refracts as it passes through second side surface of the parallelogram prism towards the upper surface of the parallelogram prism, and
(4) refracts as it passes through the upper surface of the parallelogram prism towards a first eye of a user; and
wherein a second image displayed on the display screen follows a second light path which:
(1) refracts as it passes through the lower surface of the parallelogram prism towards the first side surface of the parallelogram prism,
(2) reflects within the parallelogram prism at the first side surface of the parallelogram prism towards the second side surface of the parallelogram prism,
(3) reflects within the parallelogram prism at the second side surface towards the upper surface of the parallelogram prism, and
(4) refracts as it passes through the upper surface of the parallelogram prism towards a second eye of the user.

12. The optical device of claim 11, wherein the image is not visible to the second eye of the user and the second image is not visible to the first eye of the user.
